(19) United States
(12) Patent Application Publication
(10) Pub. No.: US 2026/0214427 A1
(43) Pub. Date: Jul. 23, 2026

(54) Methods and Systems for a Delayed Sniff Mode for Communication Channels

(71) Applicant: Google LLC, Mountain View, CA (US)

(72) Inventors: Li-Xuan Chuo, San Jose, CA (US); Qi Jiang, San Jose, CA (US); Yung-Tsung Chen, New Taipei City (TW); Daniel Jose Fernandes Barros, Sra da Hora, Porta (PT); Praveen Kumar Rayasamudra Vijayakumar, Sunnyvale, CA (US); Pei-Lin Huang, New Taipei City (TW); Ya Ping Kuo, New Taipei City (TW)

(21) Appl. No.: 19/142,461

(22) PCT Filed: Dec. 30, 2022
(86) PCT No.: PCT/US2022/082621

§ 371 Date: Jun. 23, 2025

(51) Int. Cl. H04W 4/80

(52) U.S. Cl. CPC H04W 4/80

(57) ABSTRACT

An example method includes detecting, by a base computing device configured to transmit data over a Bluetooth communication link, a pause in a transmission of data payloads to a remote computing device over the Bluetooth communication link, wherein the Bluetooth communication link is associated with a payload transmission cadence, and wherein the remote computing device is configured to receive transmitted data from the base computing device over the Bluetooth communication link. The method also includes, subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence.

### BACKGROUND

The present disclosure generally relates to a short range communication protocol, such as Bluetooth™. Devices may communicate over a Bluetooth link, such as a low-energy connected isochronous stream (CIS) link to exchange data.

### SUMMARY

The present disclosure generally relates to reducing latency in data transmission and conserving power resources. Two devices may communicate over a communication link to exchange media content. Data payloads may carry the media content over the communication link. When the media playback is paused, null payloads may be transmitted during a timeout interval, prior to termination of the communication link. The present disclosure modifies a transmission cadence of the null payloads when data transmission is paused. This enables the two devices to exchange fewer null payloads, and/or maintain the communication link for an extended period of time prior to the termination of the communication link. This enables an efficient resumption of transmission of data payloads when the two devices resume data transfer. This results in a significant reduction of latency, and conservation of power resources in a computing device communicating over the communication link.

In a first aspect, a computer-implemented method is provided. The method includes detecting, by a base computing device configured to transmit data over a Bluetooth communication link, a pause in a transmission of data payloads to a remote computing device over the Bluetooth communication link, wherein the Bluetooth communication link is associated with a payload transmission cadence, and wherein the remote computing device is configured to receive transmitted data from the base computing device over the Bluetooth communication link. The method also includes subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence.

In a second aspect, a system is provided. The system may include one or more processors. The system may also include data storage, where the data storage has stored thereon computer-executable instructions that, when executed by the one or more processors, cause the system to carry out operations. The operations may include detecting, by a base computing device configured to transmit data over a Bluetooth communication link, a pause in a transmission of data payloads to a remote computing device over the Bluetooth communication link, wherein the Bluetooth communication link is associated with a payload transmission cadence, and wherein the remote computing device is configured to receive transmitted data from the base computing device over the Bluetooth communication link. The operations may also include, subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence.

In a third aspect, a device is provided. The device includes one or more processors operable to perform operations. The operations may include detecting, by a base computing device configured to transmit data over a Bluetooth communication link, a pause in a transmission of data payloads to a remote computing device over the Bluetooth communication link, wherein the Bluetooth communication link is associated with a payload transmission cadence, and wherein the remote computing device is configured to receive transmitted data from the base computing device over the Bluetooth communication link. The operations may also include, subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence.

In a fourth aspect, an article of manufacture is provided. The article of manufacture may include a non-transitory computer-readable medium having stored thereon program instructions that, upon execution by one or more processors of a computing device, cause the computing device to carry out operations. The operations may include detecting, by a computing device configured to transmit data over a Bluetooth communication link, a pause in a transmission of data payloads to a remote computing device over the Bluetooth communication link, wherein the Bluetooth communication link is associated with a payload transmission cadence, and wherein the remote computing device is configured to receive transmitted data from the computing device over the Bluetooth communication link. The operations may also include, subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence.

In a fifth aspect, a remote computing device is provided. The remote computing device includes a controller configured to receive transmitted data from a base computing device over a Bluetooth communication link associated with a payload transmission cadence. The remote computing device includes one or more processors operable to perform operations. The operations may include detecting a pause in a transmission of data payloads from the base computing device to the remote computing device over the Bluetooth communication link. The operations also include, subsequent to detecting the pause in the transmission of the data payloads, receiving, from the base computing device, null payloads at a modified transmission cadence based on a sniff delay sequence, wherein a number of null payloads received during a time interval is smaller for the modified transmission cadence than for the payload transmission cadence.

In a sixth aspect, a computer-implemented method is provided. The method may include detecting, by a remote computing device, a pause in a transmission of data payloads from a base computing device to the remote computing device over a Bluetooth communication link, wherein the remote computing device is configured to receive transmitted data from the base computing device over the Bluetooth communication link, and wherein the Bluetooth communication link is associated with a payload transmission cadence. The method may also include, subsequent to detecting the pause in the transmission of the data payloads, receiving, from the base computing device, null payloads at a modified transmission cadence based on a sniff delay sequence, wherein a number of null payloads received during a time interval is smaller for the modified transmission cadence than for the payload transmission cadence.

In a seventh aspect, a system is provided. The system may include one or more processors. The system may also include data storage, where the data storage has stored thereon computer-executable instructions that, when executed by the one or more processors, cause the system to carry out operations. The operations may include detecting, by a remote computing device, a pause in a transmission of data payloads from a base computing device to the remote computing device over a Bluetooth communication link, wherein the remote computing device is configured to receive transmitted data from the base computing device over the Bluetooth communication link, and wherein the Bluetooth communication link is associated with a payload transmission cadence. The operations also include, subsequent to detecting the pause in the transmission of the data payloads, receiving, from the base computing device, null payloads at a modified transmission cadence based on a sniff delay sequence, wherein a number of null payloads received during a time interval is smaller for the modified transmission cadence than for the payload transmission cadence.

In an eighth aspect, an article of manufacture is provided. The article of manufacture may include a non-transitory computer-readable medium having stored thereon program instructions that, upon execution by one or more processors of a computing device, cause the computing device to carry out operations. The operations may include detecting, by a remote computing device, a pause in a transmission of data payloads from a base computing device to the remote computing device over a Bluetooth communication link, wherein the remote computing device is configured to receive transmitted data from the base computing device over the Bluetooth communication link, and wherein the Bluetooth communication link is associated with a payload transmission cadence. The operations also include, subsequent to detecting the pause in the transmission of the data payloads, receiving, from the base computing device, null payloads at a modified transmission cadence based on a sniff delay sequence, wherein a number of null payloads received during a time interval is smaller for the modified transmission cadence than for the payload transmission cadence.

In a ninth aspect, a system is provided. The system may include a base computing device configured to transmit data over a Bluetooth communication link associated with a payload transmission cadence. The system may also include a remote computing device configured to receive transmitted data from the base computing device over the Bluetooth communication link. The base computing device may include one or more processors and data storage. The data storage may have stored thereon computer-executable instructions that, when executed by the one or more processors, cause the base computing device to perform operations. The operations may include detecting a pause in a transmission of data payloads to the remote computing device over the Bluetooth communication link. The operations may also include, subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates example transmission cadences and an Audio Stream Endpoints (ASE) state transitions machine, in accordance with example embodiments.

FIG. 2 illustrates an example of modified transmission cadence at a base computing device, in accordance with example embodiments.

FIG. 3 illustrates an example of modified transmission cadence at a base computing device and a remote computing device, in accordance with example embodiments.

FIG. 4 illustrates an example of modified transmission cadence at a base computing device and a media accessory device, in accordance with example embodiments.

FIG. 5 illustrates an example comparison of different transmission cadences, in accordance with example embodiments.

FIG. 6 illustrates another example comparison of different transmission cadences, in accordance with example embodiments.

FIG. 7 illustrates another example comparison of different transmission cadences, in accordance with example embodiments.

FIG. 8 illustrates a computing device, in accordance with example embodiments.

FIG. 9 illustrates a method, in accordance with example embodiments.

FIG. 10 illustrates another method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### Overview

Separate devices, such as a mobile phone and a Bluetooth-enabled headset, may need to be paired in order to communicate with each other. At least one of the devices, referred to as a base device, may include a short-range wireless communication device that may be used to detect the presence of the other, remote device, which may also include a short-range wireless communication device. The devices may be paired using the short-range wireless communication devices using a short-range communication protocol. A communication session between the two devices may be established using a communication functionality, which may use, for example, Bluetooth or Wi-Fi.

A base computing device may transmit data to a remote computing device at a payload transmission cadence, such as a standard data transmission rate prescribed by a standards setting organization (SSO). For example, Bluetooth standards are set by the Bluetooth Special Interest Group (SIG). Accordingly, data packets (data payloads, null payloads, etc.) may be transmitted at a prescribed rate of transmission. For example, data transmission may occur over a Bluetooth communication link, such as a low-energy connected isochronous stream (CIS) communication link, and data packets may be transmitted at 10 or 20 millisecond (ms) intervals. The data transmission may include transmission of data payloads comprising media content, such as audio and/or video content. A user may pause streaming of the media content. In such instances, the transmission of data payloads may be paused. For example, the base computing device may be transmitting data payloads comprising data, such as music, video, etc., to the remote computing device, and a user may pause the music, video, etc. Generally speaking, there may be frequent disconnect/reconnect for the Bluetooth communication link due to pause/play activities.

The Bluetooth communication link may be configured to timeout in a pre-set amount of time and the link may need to be re-established when data transmission resumes (e.g., a user unpauses, or resumes playing the music, video, etc.). There may be latency associated with such a re-establishment process (approximately 1-2 seconds depending on the network environment). This can result in a noticeable delay while the user pauses and then resumes the data streaming. Such a delay can prevent a user from an enhanced media experience.

When the transmission of data payloads is paused, a number of null payloads may be transmitted (in lieu of the data payloads) at regular intervals. The timeout period may be fixed, or a specified number of null payloads may need to be sent. However, sending such null payloads imposes additional burden on the power resources of a computing device. Although the timeout period may be extended, this can cause additional consumption of power resources. This can be especially significant for mobile devices that operate in a constrained power resource environment. Effectively managing a trade-off between maintaining a communication link for an extended timeout interval and conserving power resources can be challenging.

Accordingly, there is a need for a modified transmission cadence for null payloads that enables a transmission of fewer null payloads during a preset timeout interval, or extends the existing timeout interval when a preset number of null payloads are to be transmitted. For example, when data transmission is paused, the connection interval for a timeout may be extended. Instead of initiating an Audio Stream Endpoints (ASE) release and/or a CIS termination after a short period of timeout, an extended period may be provided. This can utilize limited computing resources, and can substantially reduce and/or eliminate the latency in re-establishing the transmission of data payloads.

Such a protocol may be advantageous to users by providing them with continued enjoyment of media content, by reducing latency in data transmission, conserving power resources in a constrained resource environment, and/or reducing a thermal activity for the device.

### Example Modified Transmission Cadence

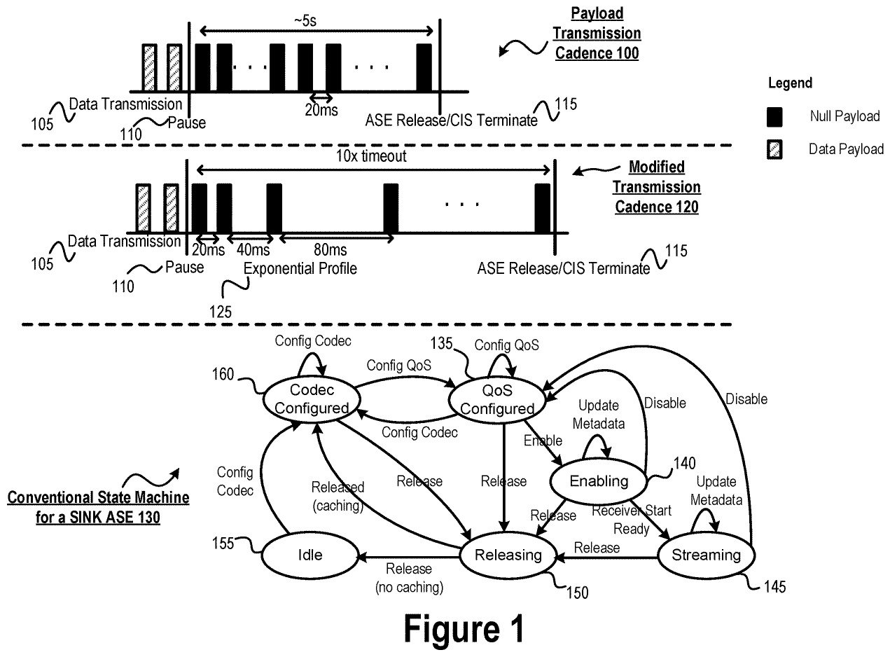

FIG. 1 illustrates example transmission cadences and an Audio Stream Endpoints (ASE) state transitions machine, in accordance with example embodiments. For example, a payload transmission cadence 100 is illustrated. A base computing device may transmit data comprising payload data 105 to a remote computing device at an existing payload transmission cadence. For example, payload data 105 may be transmitted at 20 millisecond (ms) intervals. For illustrative purposes, some example embodiments are described with reference to a Bluetooth communication link, such as a low-energy connected isochronous stream (CIS) communication link. However, the techniques described herein may be applicable to any type of data transmission where data payloads are replaced with null payloads during a timeout interval after the transmission of the data payloads is paused. For example, data transmission may occur over other communication links with a pre-configured payload transmission cadence. For example, a standard settings organization (SSO) for a communication link may prescribe a standard for the payload transmission cadence.

Some embodiments involve detecting, by the base computing device configured to transmit data over a Bluetooth communication link, a pause in a transmission of data payloads to the remote computing device over the Bluetooth communication link, wherein the Bluetooth communication link is associated with a payload transmission cadence, and wherein the remote computing device is configured to receive transmitted data from the base computing device over the Bluetooth communication link. For example, the data transmission of payload data 105 may be paused at pause 110. For example, the base computing device may be transmitting payload data comprising media content such as music, video, etc., to a remote computing device, and a user may pause the streaming of the media content. When pause 110 occurs, there may be a timeout interval during which the base computing device may maintain the communication link with the remote computing device. In some embodiments, an existing payload transmission cadence may include terminating the communication link when the timeout interval ends. For example, an Audio Stream Endpoints (ASE) release and/or a CIS termination 115 may be initiated, resulting in a termination of the communication link.

In some embodiments, an SSO may prescribe the timeout interval to be of a fixed duration (e.g., 5 seconds). For example, the SSO may prescribe a timeout duration (T) and a packet interval (packet_interval). Accordingly, a number of null payloads to be transmitted may be determined as T/packet_interval. In some embodiments, a fixed number of null payloads may need to be transmitted by the base computing device during the timeout interval. Accordingly, at pause 110, transmission of null payloads (instead of the data payloads) may be initiated as part of a sniff protocol. Generally speaking, there may be frequent disconnect/reconnect for the communication link when pause 110 occurs. The null payloads enable the base computing device to enter a power saving mode in between the disconnect/reconnect for the communication link. However, repetitive transmission of the null payloads can drain the power resources of the base computing device. Also, for example, when an Audio Stream Endpoints (ASE) release and/or a CIS termination, ASE/CIS 115, is initiated, there may be a noticeable delay in reinitializing the transmission process to resume transmission of data payloads, and this may cause a perceptible latency in resuming data transmission after pause 110.

Some embodiments involve, subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence. For example, the existing payload transmission cadence 100 may involve payload transmission at a plurality of regular transmission intervals based on a transmission frequency. For example, the regular transmission interval may be of length 20 ms. Accordingly, based on the existing payload transmission cadence 100, payload transmissions (e.g., data payload and null payload) may occur at integer multiples of 20 ms, such as at times t=0, 20, 40, 60, 80, . . . , and so forth. For example, for payload transmission cadence 100, when a transmission of a first null payload subsequent to pause 110 is initialized to correspond to t=0, and the timeout interval is 5 s, the null payloads may be transmitted at time t where t=0, 20, 40, 60, 80, . . . , J−1 with a regular transmission interval of 20 ms. Accordingly, a transmission sequence based on the payload transmission cadence 100 may be 20t, t=0, 1, . . . , J−1, in the illustrated example.

Also illustrated is a modified transmission cadence 120 based on a sniff delay sequence, where a number of null payloads transmitted during a time interval is smaller for the modified transmission cadence 120 than for the payload transmission cadence 100. For example, instead of transmitting the null payloads at times t=0, 20, 40, 60, 80, 100, and so forth as per the payload transmission cadence 100, under the modified transmission cadence 120, the regular transmission interval of 20 ms is modified, and null payloads may be transmitted with an exponential delay at time intervals of 20 ms, 40, ms, 80 ms, and so forth. Accordingly, the null payloads may be transmitted at t=0, 20, 60, 100, 180, and so forth.

As described herein, the sniff delay sequence may refer to the sequence of times at which the null payloads are transmitted, and/or a sequence of lengths of time intervals between successive null payload transmissions. In some embodiments, the payload transmission cadence comprises payload transmission at a plurality of regular transmission intervals based on a transmission frequency, and wherein the sniff delay sequence comprises transmission of the null payloads during a subset of the plurality of regular transmission intervals. Generally speaking, any sequence compatible with the existing payload transmission cadence 100 may be used. For example, the sniff delay sequence may be any subset tᵢ of t=0, 20, 40, 60, 80, . . . , 20(J−1). More generally, when the regular transmission interval is of length M, then the sniff delay sequence may be any subset tᵢ of t=0, M, 2M, 3M, 4M, . . . , M(J−1).

In some embodiments, the sniff delay sequence may be a preset sequence or an exponential sniff delay sequence. For example, the connection interval may be extended by multiples of 20 ms from the base device (e.g., mobile device) when data transmission has paused at pause 110, instead of initiating ASE/CIS 115 after a short period of timeout. As illustrated, an exponential profile 125 may include transmitting a first data packet after the regular transmission interval (e.g., 20 ms), a second data packet after a second time interval, and a third data packet after a third time interval, wherein the second time interval is K-times the length of the regular transmission interval, and the third time interval is K-times the length of the second time interval, and so forth. In some embodiments, K=2 and the existing regular transmission interval is 20 ms. Accordingly, the next packet may be transmitted after 20×2=40 ms, and the third data packet may be transmitted after 40×2=80 ms. Such an exponential profile 125 may extend the preset timeout (e.g., 5000 ms) by a substantial factor. Generally, an amount of extension may depend on a variety of factors, including, but not limited to, a null payload interval profile, power consumption constraints, and so forth.

In some embodiments, the base computing device may be configured to store a plurality of candidate sniff delay sequences, and wherein the sniff delay sequence is selected from the plurality of candidate sniff delay sequences. For example, the base computing device may store the candidate sniff delay sequences in an application specific integrated circuit (ASIC) associated with the base computing device. In some embodiments, the sniff delay sequence and/or candidate sniff delay sequences may be hardcoded in the hardware for the base computing device and/or the remote computing device.

In some embodiments, the sniff delay sequence and/or candidate sniff delay sequences may be stored and/or programmed from a host software and/or firmware. Additional and/or alternative means for retrieving and/or storing the sniff delay sequence and/or candidate sniff delay sequences may be implemented based on the base computing device, the remote computing device, and/or a networking environment.

In some embodiments, the sniff delay sequence may be selected based on one or more of network bandwidth, or a power level of the base computing device. For example, the base computing device may obtain network data from a network communications module and may select the sniff delay sequence based on the network characteristics. For example, upon a determination that the network has limited bandwidth, the base computing device may select a sniff delay sequence where the null payload transmissions are less frequent, and/or spread out. Also, for example, the base computing device may obtain device characteristics from a device controller, and may select the sniff delay sequence based on the device characteristics. For example, upon a determination that the device has limited power resources, the base computing device may select a sniff delay sequence where the null payload transmissions are less frequent, and/or spread out.

In some embodiments, the remote computing device may be configured to receive the null payloads based on the modified transmission cadence 120. Such embodiments involve communicating the selected sniff delay sequence to the remote computing device prior to the initiating of the transmission of the null payloads based on the modified transmission cadence. For example, subsequent to pause 110, the base computing device may send an information payload with information about the selected sniff delay sequence. The remote computing device may also be configured to store the plurality of candidate sniff delay sequences, and upon receiving the information payload, the remote computing device may adjust the transmission cadence to conform to the selected sniff delay sequence. The remote computing device may be configured to manage receipt (and acknowledgement) of data payloads and/or null payloads based on the payload transmission cadence for the Bluetooth communication link. Also, for example, the remote computing device may be configured to manage receipt (and acknowledgement) of null payloads based on the modified transmission cadence. In some embodiments, the remote computing device may receive the sniff delay sequence from the base computing device, and may synchronize receipt of the null payloads with the transmission of the null payloads by the base computing device.

FIG. 1 also illustrates an Audio Stream Endpoints (ASE) state transitions machine for a sink ASE 130. In some embodiments, the CIS communication link comprises a state transitions machine. The oval shaped nodes represent the states of the ASE state machine. The labeled arrows represent ASE Control operations which can cause a transition of the ASE state machine and/or change the parameter values of an ASE. In one example transition, at node 135, a QoS may be configured. For example, node 160 may configure the codec and send an instruction to node 135 to configure QoS. Also, for example, node 135 may iteratively update a QoS config file, send an enable instruction to node 140, and/or send a release instruction to node 150. Node 140 may update metadata, send a release instruction to node 150, send a receiver start/ready signal to node 145, and/or send a disable instruction to node 135. Node 145 may update metadata, initiate streaming, and/or send a disable instruction to node 135. In some embodiments, node 150 may receive release instructions from one or more of nodes 135, 140, 145, or 160. In turn, node 150 may release the data with caching to node 160, and without caching to node 155. Node 155 may represent an idle state, and send codec config data to node 160. As previously stated, when data transmission is paused, the operations exit sink ASE 130. Accordingly, each time data transmission is resumed, sink ASE 130 has to be reinitialized, causing delay in resumption of data streaming.

In classic Bluetooth (BT) Advanced Audio Distribution Profile (A2DP), when an exit sniff and an A/V Distribution Transport Protocol (AVDTP) start are performed in parallel, the total set up time, say T1, may indicate a delay between when a user presses a “Play” button and when the music begins to stream. However, low energy (LE) Audio may involve two earbuds, one for the left ear and one for the right ear. Accordingly, two CIS operations may need to be performed, such as, for example, a CIS1 operation (e.g., corresponding to the left earbud) and a CIS2 operation (e.g., corresponding to the right earbud). The total performance time for the CIS1 operation (including CIS1 Enable, Create CIS1, CIS1 Receiver ready, and so forth) and for the CIS2 operation (including CIS2 Enable, Create CIS2, CIS2 Receiver ready, and so forth) may be T2. The total time T2 to perform CIS1 and CIS2 is generally higher than the time T1 for classic BT, resulting in a substantial latency.

As described herein, the replacing of the existing payload transmission cadence involves bypassing the state transitions machine to initiate the modified transmission cadence. Keeping ASE state and/or Bluetooth communication link running can be computationally expensive, including use of limited power resources. Additionally, such continued use may adversely affect a thermal profile of the device. Although the ASE state and/or Bluetooth communication link may be maintained for a short period of time to maintain a trade-off between user experience regression and power consumption, such a trade-off begins to impact the power consumption and/or diminish user experience (e.g., heated device), after a short time.

In some embodiments, the initiating of the transmission of the null payloads based on the modified transmission cadence may commence after passage of a threshold of time. For example, upon an occurrence of pause 110, the base computing device may maintain active state transitions and an active link for a threshold amount of time, in case the streaming of the media content is resumed within the threshold amount of time.

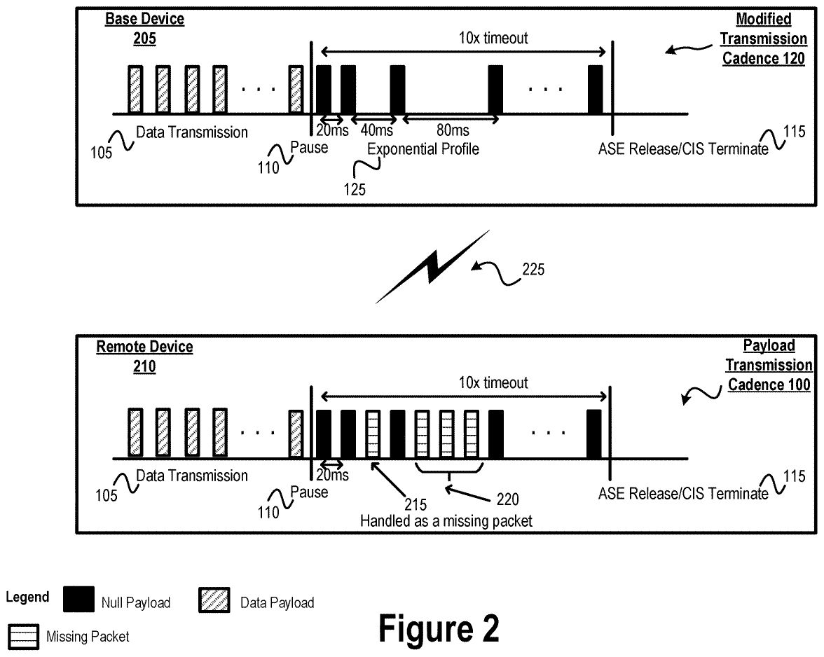

FIG. 2 illustrates an example of modified transmission cadence at a base computing device, in accordance with example embodiments. FIG. 2 may share one or more aspects in common with FIG. 1. For example, base device 205 may be communicating with remote device 210 over communication link 225. In some embodiments, base device 205 may implement modified transmission cadence 120 with the sniff delay sequence. For example, base device 205 may implement the exponential profile 125 based on an exponential sniff delay sequence . . . .

Base device 205 may, in some examples, include, be, or be part of a portable computing device (for example, a mobile phone, netbook, laptop, personal data assistant (PDA), tablet device, portable gaming device, portable media player, e-book reader, watch, etc.) as well as non-portable devices (for example, a desktop computer). The remote device 210 may, in some examples, include, be, or be part of an input/output device (for example, a headset, speakers, video display device), a peripheral device (for example, a printer, scanner, etc.), a vehicle (for example, a passenger car), a media playback device, a mobile device communicating with the base device 205, a camera, a virtual reality (VR) device, an augmented reality (AR) device, or any other device capable of pairing and communicating with another computing device. In some embodiments, base device 205 may function as a remote device with respect to another base device. For example, two mobile devices may communicate with each other over Bluetooth. The techniques described herein may be applicable to unicast as well as multicast transmission.

In some embodiments, the remote computing device may be configured with the existing payload transmission cadence. For example, remote device 210 may implement a payload transmission cadence 100 based on the existing regular transmission interval (e.g., 20 ms). Accordingly, when base device 205 sends a null payload after a 40 ms interval, the remote device 210, expecting a null payload every 20 ms, may miss one null payload as indicated by missed packet 215. Accordingly, remote device 210 may handle the missed packet 215 as having been missed during standard data transmission. Similarly, when base device 205 sends a null payload after a 80 ms interval, the remote device 210, expecting a null payload every 20 ms, will miss three null payloads as indicated by missed packets 220. Accordingly, remote device 210 may handle the missed packets 220 as having been missed during standard data transmission.

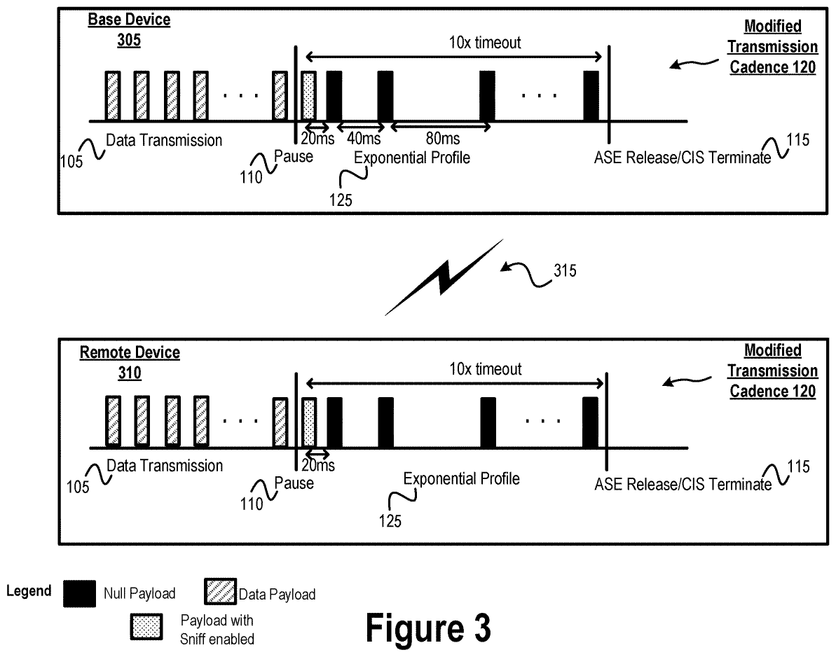

FIG. 3 illustrates an example of modified transmission cadence at a base computing device and a remote computing device, in accordance with example embodiments. FIG. 3 may share one or more aspects in common with FIGS. 1 and 2. For example, base device 305 may be communicating with remote device 310 over communication link 315. In some embodiments, the remote computing device may be configured to receive the null payloads based on the modified transmission cadence, and wherein the remote computing device may be configured to synchronize receipt of the null payloads from the base computing device based on the sniff delay sequence. Generally, the base computing device may include a base controller, and the remote computing device may include a remote controller, and the base controller and the remote controller may be configured to synchronize respective transmission and receipt of null payloads based on the sniff delay sequence. For example, base device 305 and remote device 310 may both implement modified transmission cadence 120 based on the sniff delay sequence. For example, base device 305 and remote device 310 may implement the exponential profile 125 based on an exponential sniff delay sequence. As illustrated, the base controller and the remote controller may be configured to synchronize the transmission and receipt of null payloads based on exponential profile 125.

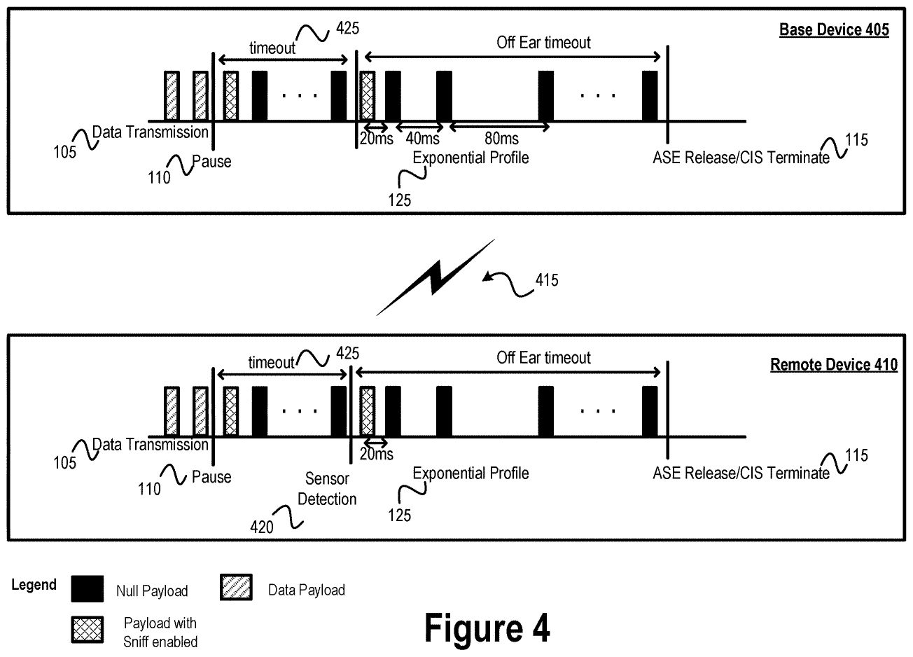

FIG. 4 illustrates an example of modified transmission cadence at a base computing device and a media accessory device, in accordance with example embodiments. FIG. 4 may share one or more aspects in common with FIGS. 1, 2, and 3. For example, base device 405 may be communicating with remote device 410 over communication link 415. In some embodiments, the remote computing device may be a media accessory device (e.g., earbuds, a Bluetooth headset, virtual reality (VR) headset, augmented reality (AR) headset, etc.). Some embodiments involve detecting that the media accessory device is removed from use by a user. For example, motion sensors attached to a Bluetooth headset may perform sensor detection 420 that the Bluetooth headset has been removed from the ear. Generally, this may indicate that the user wishes to pause and/or terminate streaming of the media content.

Such embodiments may involve waiting, for a threshold amount of time, indicated by timeout 425. For example, instead of initiating an extended sniff delay profile subsequent to pause 110, the base device 405 may wait for the threshold amount of time (e.g., timeout 425) to ensure that the media accessory device is not placed back in use. However, once the threshold amount of time has passed, then the base device 405 may initiate the sniff delay profile. In conventional settings, an existing payload transmission cadence 100 of FIG. 1 may be initiated to transmit the null payloads. However, based on the techniques described herein, a modified transmission cadence 120 of FIG. 1 based on a sniff delay sequence (e.g., exponential profile 125) may be initiated subsequent to a passage of the threshold amount of time, timeout 425. As illustrated, the base device 405 and the remote device 410 may be configured to synchronize timeout 425 and the transmission of null payloads based on the sniff delay sequence, referred to in FIG. 4 as an “off ear timeout.”

Generally, the “off ear timeout” may be set to 5 s. It is desirable to maintain the “off ear timeout” to be less than or equal to the total timeout. In some embodiments, a pseudocode such as the4 one presented below may be used:

If (timeout − timer > off_ear_timeout),
Then timeout = off_ear_timeout,
Else timeout = timeout.

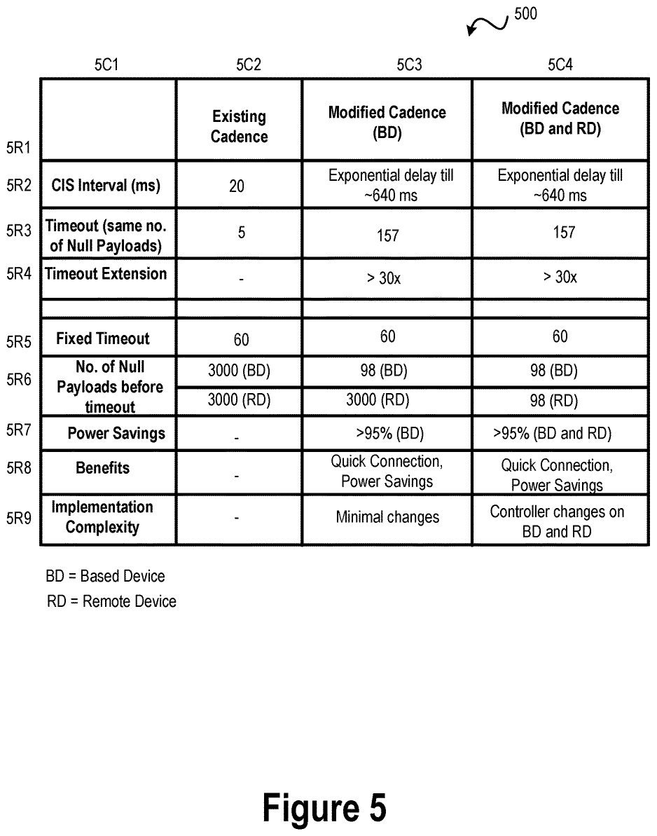

FIG. 5 illustrates an example comparison of different transmission cadences, in accordance with example embodiments. Table 500 includes four columns 5C1, . . . , 5C4, and nine rows, 5R1, . . . , 5R9. Colum 5C1 lists various device features. Column 5C2 indicates the values for the device features for a current connectivity design. Column 5C3 indicates the values for the device features when the base device is in sniff mode and the remote device is in standard mode (e.g., illustrated in FIG. 2), and column 5C4 indicates the values for the device features when the base device and the remote device are in sniff mode (e.g., illustrated in FIG. 3).

As indicated in row 5R2, the existing payload transmission cadence corresponds to a regular transmission interval of 20 ms. However, with a modified transmission cadence based on the exponential profile illustrated herein (20 ms, 40 ms, 80 ms, and so forth), the timeout interval can be extended (e.g., up to approximately 640 ms in an example implementation based on a classic BT A2DP sniff mode parameter of approximately 500 ms). Also, for example, when a same number of null payloads are to be transmitted (e.g., to maintain the same level of power consumption, and/or reduce power consumption), the timeout interval for the existing payload transmission cadence can be, for example, 5 s, whereas the timeout interval for the modified transmission cadence may be extended to, for example, 157 s. Row 5R4 indicates that, in some example implementations, a timeout extension of approximately greater than 30× may be achieved based on a modified transmission cadence.

As indicated in row 5R5, the fixed timeout interval may be set to 60 seconds. In this case, row 5R6 illustrates that the existing payload transmission cadence corresponds to transmission of 3000 null payloads. However, the modified transmission cadence corresponds to 98 null payload transmissions, a substantial improvement over the 3000 transfers for the existing payload transmission cadence. Similarly, when the remote computing device is configured with the existing payload transmission cadence, it expects to receive 3000 null payload transmissions, however only 98 are transmitted; the remainder being handled as missing data packets. However, in the event that both the base computing device and the remote computing device are configured with the modified transmission cadence, 98 null payloads are transmitted and received, resulting in significant power savings for both devices. Also, as indicated in row 5R7, columns 5C3 and 5C4, a significant power savings (e.g., greater than 95%) may be achieved in both cases. This is especially significant when the remote computing device is a media accessory device, such as an earbud, with limited power resources. Additional and/or alternative improvements are illustrated in table 500.

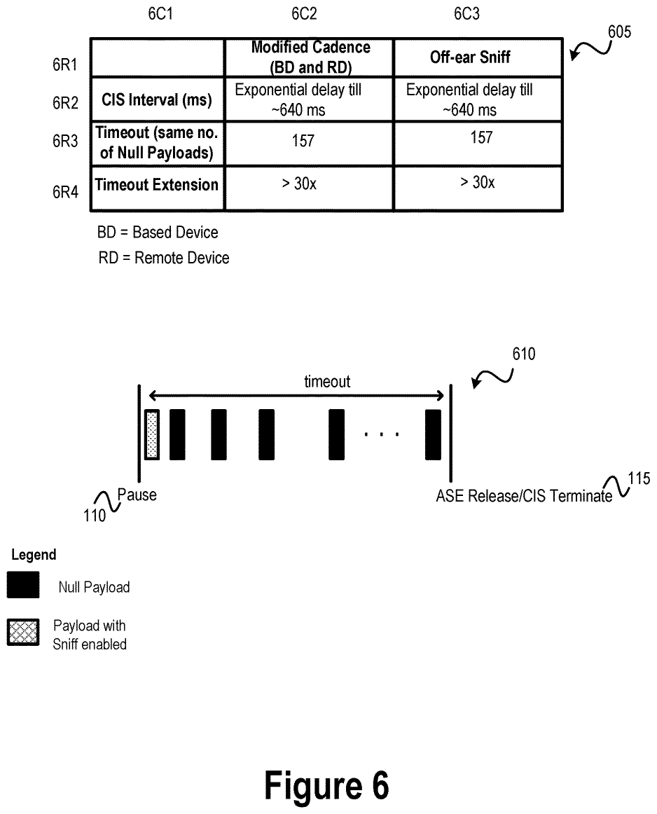

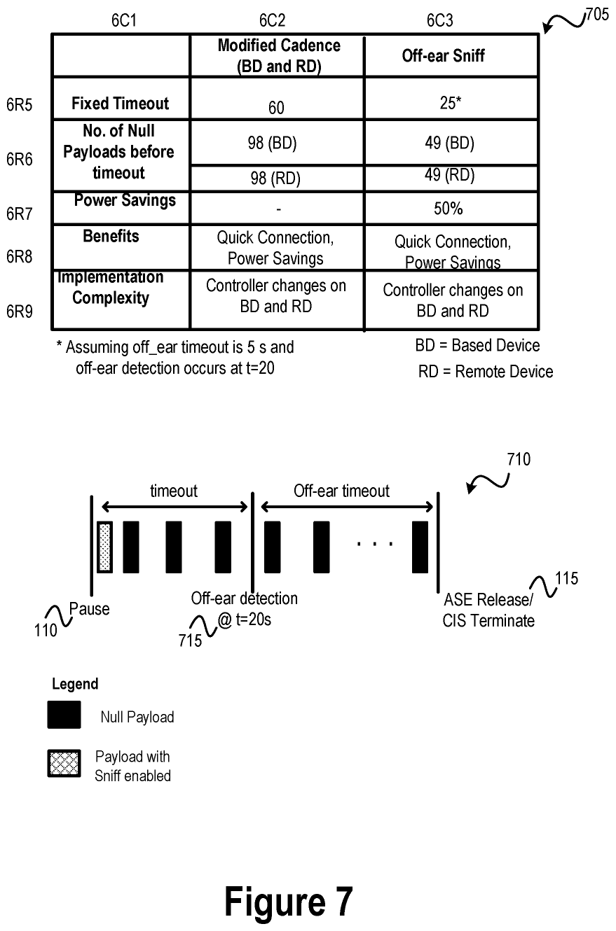

FIGS. 6 and 7 illustrate another example comparison of different transmission cadences, in accordance with example embodiments. Tables 605 and 705 include 3 columns labeled 6C1, 6C2, and 6C3, and together include nine rows (similar to table 500 of FIG. 5), 6R1 to 6R9. Rows 6R1 to 6R4 are presented in table 605 of FIG. 6 and rows 6R5 to 6R9 are presented in table 705 of FIG. 7. Colum 6C1 lists various device features. Column 6C2 indicates the values for the device features when the base device and the remote device are configured for the modified transmission cadence (e.g., illustrated in FIG. 3), and column 6C3 indicates the values for off ear mode (e.g., illustrated in FIG. 4). Referring to FIG. 6, as indicated, the exponential delay may extend the timeout interval by approximately 640 ms for both cases (see 6R2). A timeout with the same number of packet transmissions may be 157 s (see 6R3), and the timeout extension may be or the order of greater than 30× (see 6R4). This is based on the sniff profile 610 case when the base device and the remote device are both configured for the modified transmission cadence (e.g., illustrated in FIG. 3).

As indicated in row 6R9 of table 705 in FIG. 7, both devices may need to be configured for the modified transmission cadence. This is based on the sniff profile 710 with off-ear detection 715 occurring at 20 s, when the base device and the remote device are in the off ear mode (e.g., illustrated in FIG. 4).

### Example Computing Devices

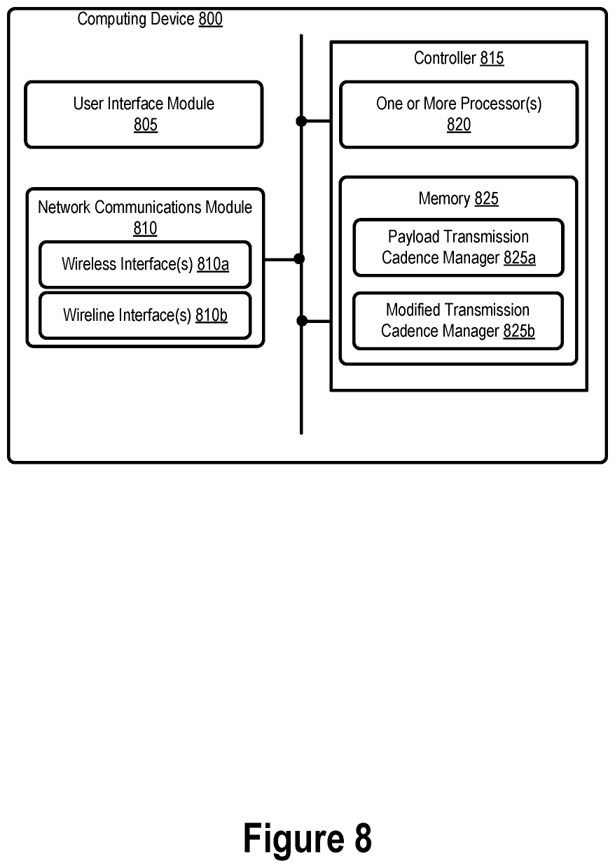

FIG. 8 illustrates a computing device, in accordance with example embodiments. Computing device 800 includes user interface module 805, network communications module 810, and controller 815. Controller 815 may include one or more processor(s) 820, and memory 825. In some embodiments, network communications module 810 may include wireless interface(s) 810a, and wireline interface(s) 810b. In some examples, computing device 800 may take the form of a desktop device, a server device, or a mobile device. In some embodiments, computing device 800 may share one or aspects with a base computing device, and/or with a remote computing device (e.g., a media accessory device), as described herein. The example components illustrated in FIG. 8 are for illustrative purposes only. In particular, computing device 800 may include additional and/or alternative hardware and/or software components that enable data transmission. For example, computing device 800 may include additional and/or alternative hardware and/or software components that implement one or more standards set by an SSO, such as a Bluetooth standard.

User interface module 805 may be configured to provide output signals to a user and receive input signal from a user by way of one or more screens (including touch screens), cathode ray tubes (CRTs), liquid crystal displays (LCDs), light emitting diodes (LEDs), organic LEDs (OLEDs), displays using digital light processing (DLP) technology, and/or other similar technologies. User interface module 805 may also be configured to generate audible outputs, such as with a speaker, speaker jack, audio output port, audio output device, earphones, and/or other similar devices. User interface module 805 may further be configured with one or more haptic components that can generate haptic outputs, such as vibrations and/or other outputs detectable by touch and/or physical contact with computing device 800.

In some embodiments, user interface module 805 may be configured to provide a Wi-Fi picker that displays a list of names (e.g., SSIDs) for available networks. In some embodiments, user interface module 805 may be configured to provide a temporary identifier indicative of the wireless network in the Wi-Fi picker, and an associated user interface element to receive the user confirmation. For example, user interface module 805 may be configured to provide a pseudo entry in the Wi-Fi picker that would include a network friendly name (e.g., based on an ANQP response), and a message below the entry that may indicate “Tap to sign-up”. Also, for example, user interface module 805 may be configured to detect user confirmation to join the network. In some embodiments, user interface module 805 may be configured to provide an interactive display of a web browser that facilitates exchange of subscription data.

Network communications module 810 can include one or more wireless interfaces and/or wireline interfaces that are configurable to communicate via a network. Wireless interfaces 310a can include one or more wireless transmitters, receivers, and/or transceivers, such as a Bluetooth™ transceiver, a Zigbee® transceiver, a Wi-Fi™ transceiver, a WiMAX™ transceiver, and/or other similar types of wireless transceivers configurable to communicate via a wireless network. Wireline interfaces 310b can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network communications module 810 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

Controller 815 may include one or more processor(s) 820 and memory 825. Processor(s) 820 can include one or more general purpose processors and/or one or more special purpose processors (e.g., display driver integrated circuit (DDIC), digital signal processors (DSPs), tensor processing units (TPUs), graphics processing units (GPUs), application specific integrated circuits (ASICs), etc.). Processor(s) 820 may be configured to execute computer-readable instructions that are contained in memory 825 and/or other instructions as described herein.

Memory 825 may include one or more non-transitory computer-readable storage media that can be read and/or accessed by processor(s) 820. The one or more non-transitory computer-readable storage media can include volatile and/or non-volatile storage components, such as optical, magnetic, organic, or other memory or disc storage, which can be integrated in whole or in part with at least one of processor(s) 820. In some examples, memory 825 can be implemented using a single physical device (e.g., one optical, magnetic, organic or other memory or disc storage unit), while in other examples, memory 825 can be implemented using two or more physical devices.

In example embodiments, processor(s) 820 are configured to execute instructions stored in memory 825 to carry out operations.

In example embodiments, computing device 800 may be a base computing device (e.g., base devices 205, 305, and/or 405) configured to transmit data over a Bluetooth communication link associated with a payload transmission cadence. The base computing device may communicate with a remote computing device configured to receive transmitted data from the base computing device over the Bluetooth communication link.

The operations may include detecting, by the base computing device, a pause in a transmission of data payloads to the remote computing device over the Bluetooth communication link.

The operations may also include subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence.

In some embodiments, the operations may be performed by one or more managers that may be configured to perform the operations. The one or more managers may include a payload transmission cadence manager 825a and a modified transmission cadence manager 825b. The payload transmission cadence manager 825a may be configured to manage transmission of data payloads based on the payload transmission cadence for the Bluetooth communication link. Also, for example, modified transmission cadence manager 825b may be configured to manage transmission of null payloads based on the modified transmission cadence. In some embodiments, modified transmission cadence manager 825b may select the sniff delay sequence from a plurality of candidate sniff delay sequences (e.g., stored in memory 825), or in an application specific integrated circuit (ASIC) linked to controller 815. For example, modified transmission cadence manager 825b may obtain network data from network communications module 810 and may select the sniff delay sequence based on the network characteristics. For example, based on the network data and upon a determination that the network has limited bandwidth, the modified transmission cadence manager 825b may select a sniff delay sequence where the null payload transmissions are less frequent, and/or spread out. Also, for example, modified transmission cadence manager 825b may obtain device characteristics from controller 815, and may select the sniff delay sequence based on the device characteristics. For example, upon a determination that the device has limited power resources, the modified transmission cadence manager 825b may select a sniff delay sequence where the null payload transmissions are less frequent, and/or spread out.

In example embodiments, computing device 800 may be a remote computing device (e.g., remote devices 210, 310, and/or 410), including controller 815 configured to receive transmitted data from a base computing device over a Bluetooth communication link associated with a payload transmission cadence.

The operations may include detecting a pause in a transmission of data payloads from the base computing device to the remote computing device over the Bluetooth communication link.

The operations may also include subsequent to detecting the pause in the transmission of the data payloads, receiving, from the base computing device, null payloads at a modified transmission cadence based on a sniff delay sequence, wherein a number of null payloads received during a time interval is smaller for the modified transmission cadence than for the payload transmission cadence.

In some embodiments, the operations may be performed by one or more managers that may be configured to perform the operations. The one or more managers may include a payload transmission cadence manager 825a and a modified transmission cadence manager 825b. The payload transmission cadence manager 825a may be configured to manage receipt (and acknowledgement) of data payloads and/or null payloads based on the payload transmission cadence for the Bluetooth communication link. Also, for example, modified transmission cadence manager 825b may be configured to manage receipt (and acknowledgement) of null payloads based on the modified transmission cadence. In some embodiments, modified transmission cadence manager 825b may receive the sniff delay sequence from the base computing device, and may synchronize receipt of the null payloads with the transmission by the base computing device.

### Example Methods

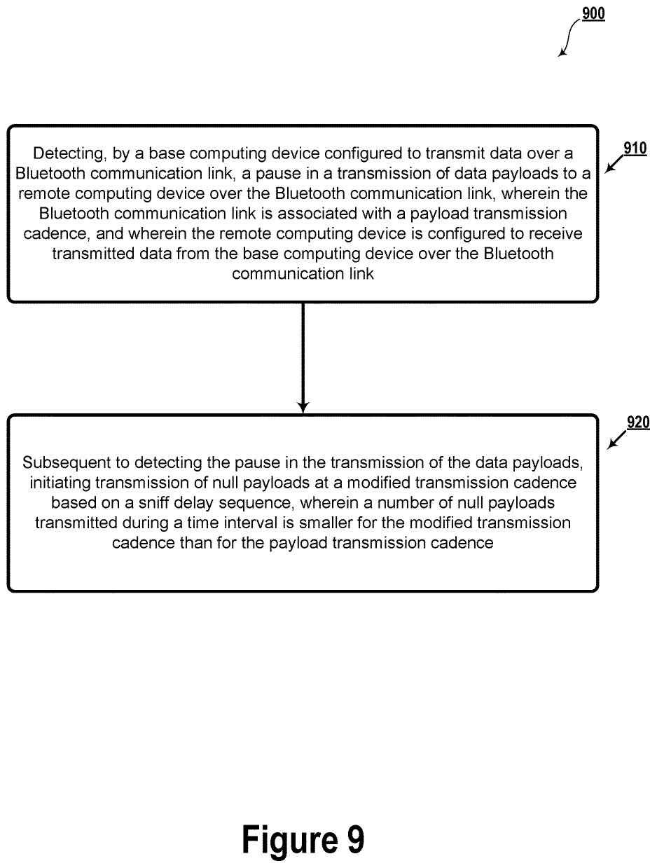

FIG. 9 illustrates a method 900, in accordance with example embodiments. Method 900 may include various blocks or steps. The blocks or steps may be carried out individually or in combination. The blocks or steps may be carried out in any order and/or in series or in parallel. Further, blocks or steps may be omitted or added to method 900.

The blocks of method 900 may be carried out by various elements of computing device 800 (e.g., base computing device) of FIG. 8, and/or base devices 205, 305, and/or 405, as illustrated and described with reference to the respective figures.

Block 910 involves detecting, by a base computing device configured to transmit data over a Bluetooth communication link, a pause in a transmission of data payloads to a remote computing device over the Bluetooth communication link, wherein the Bluetooth communication link is associated with a payload transmission cadence, and wherein the remote computing device is configured to receive transmitted data from the base computing device over the Bluetooth communication link.

Block 920 involves, subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence.

In some embodiments, the Bluetooth communication link includes a low-energy connected isochronous stream (CIS) communication link.

In some embodiments, the Bluetooth communication link is configured to be terminated after a preset timeout interval, and wherein the modified transmission cadence extends the preset timeout interval.

In some embodiments, the payload transmission cadence comprises payload transmission at a plurality of regular transmission intervals based on a transmission frequency, and wherein the sniff delay sequence comprises transmission of the null payloads during a subset of the plurality of regular transmission intervals.

In some embodiments, the sniff delay sequence may include a preset sequence.

In some embodiments, the sniff delay sequence may include an exponential sniff delay sequence.

Some embodiments involve transmitting, to the remote computing device and based on the exponential sniff delay sequence, a first data packet after a first time interval, a second data packet after a second time interval, and a third data packet after a third time interval. The first time interval may be initialized when the transmission of the data payload has been paused. The first time interval may be of the same length as the regular transmission interval. The second time interval may be K-times the length of the regular transmission interval, and the third time interval may be K-times the length of the second time interval. In some embodiments, K is two, and/or the regular transmission interval is of length twenty milliseconds.

In some embodiments, the remote computing device is configured to receive the null payloads based on the payload transmission cadence.

In some embodiments, the remote computing device may be configured to receive the null payloads based on the modified transmission cadence, and wherein the remote computing device may be configured to synchronize receipt of the null payloads from the base computing device based on the sniff delay sequence.

In some embodiments, the remote computing device may be a media accessory device. Such embodiments involve detecting that the media accessory device is removed from use by a user. Such embodiments also involve subsequent to the detecting that the media accessory device is removed, waiting for a threshold amount of time. The initiating of the transmission of the null payloads may be based on the modified transmission cadence commences after passage of the threshold of time.

In some embodiments, the base computing device may be configured to store a plurality of candidate sniff delay sequences, and wherein the sniff delay sequence is selected from the plurality of candidate sniff delay sequences.

In some embodiments, the sniff delay sequence may be selected based on one or more of network bandwidth, or a power level of the base computing device.

In some embodiments, the remote computing device may be configured to receive the null payloads based on the modified transmission cadence. Such embodiments involve communicating the selected sniff delay sequence to the remote computing device prior to the initiating of the transmission of the null payloads based on the modified transmission cadence.

In some embodiments, the initiating of the transmission of the null payloads based on the modified transmission cadence may commence after passage of a threshold of time.

In some embodiments, the Bluetooth communication link may be associated with an Audio Stream Endpoints (ASE) state transitions machine, and wherein the initiating of the transmission of the null payloads based on the modified transmission cadence comprises bypassing the ASE state transitions machine.

In some embodiments, the data transmission may include transmission of audio and/or video packets.

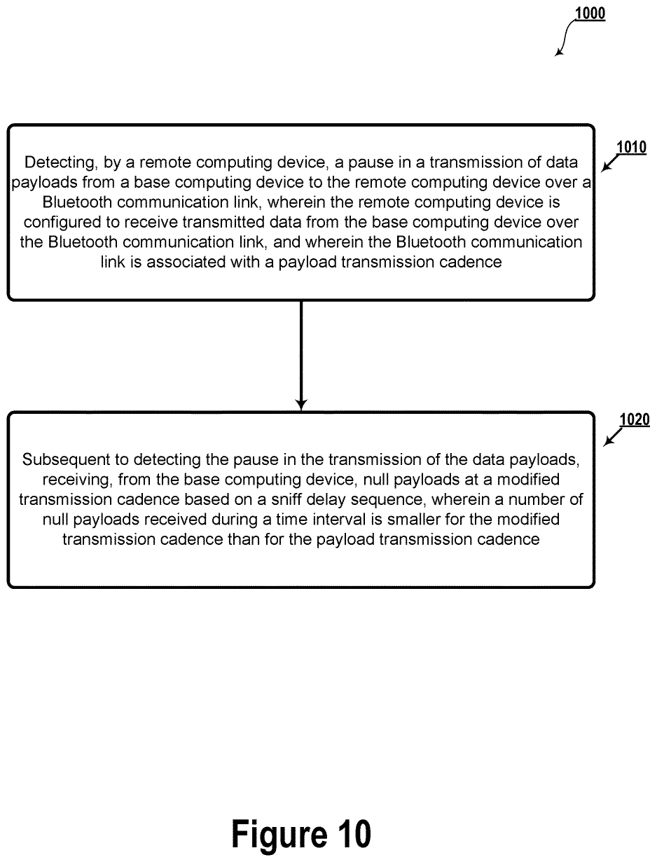

FIG. 10 illustrates a method 1000, in accordance with example embodiments. Method 1000 may include various blocks or steps. The blocks or steps may be carried out individually or in combination. The blocks or steps may be carried out in any order and/or in series or in parallel. Further, blocks or steps may be omitted or added to method 1000.

The blocks of method 1000 may be carried out by various elements of computing device 800 (e.g., remote computing device) of FIG. 8, and/or remote devices 210, 310, and/or 410, as illustrated and described with reference to the respective figures.

Block 1010 involves detecting, by a remote computing device, a pause in a transmission of data payloads from a base computing device to the remote computing device over a Bluetooth communication link, wherein the remote computing device is configured to receive transmitted data from the base computing device over the Bluetooth communication link, and wherein the Bluetooth communication link is associated with a payload transmission cadence.

Block 1020 involves, subsequent to detecting the pause in the transmission of the data payloads, receiving, from the base computing device, null payloads at a modified transmission cadence based on a sniff delay sequence, wherein a number of null payloads received during a time interval is smaller for the modified transmission cadence than for the payload transmission cadence.

In some embodiments, the Bluetooth communication link comprises a low-energy connected isochronous stream (CIS) communication link.

In some embodiments, the Bluetooth communication link may be configured to be terminated after a preset timeout interval, and wherein the modified transmission cadence extends the preset timeout interval.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods. Thus, the computer readable media may include secondary or persistent long-term storage, like read only memory (ROM), optical or magnetic disks, compact disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A system, comprising:
a base computing device configured to transmit data over a Bluetooth communication link associated with a payload transmission cadence;
a remote computing device configured to receive transmitted data from the base computing device over the Bluetooth communication link; and
wherein the base computing device comprises one or more processors and data storage, and wherein the data storage has stored thereon computer-executable instructions that, when executed by the one or more processors, cause the base computing device to perform operations comprising:
detecting a pause in a transmission of data payloads to the remote computing device over the Bluetooth communication link; and
subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence.

2. The system of claim 1, wherein the Bluetooth communication link comprises a low-energy connected isochronous stream (CIS) communication link.

3. The system of claim 1, wherein the Bluetooth communication link is configured to be terminated after a preset timeout interval, and wherein the modified transmission cadence extends the preset timeout interval.

4. The system of claim 1, wherein the payload transmission cadence comprises payload transmission at a plurality of regular transmission intervals based on a transmission frequency, and wherein the sniff delay sequence comprises transmission of the null payloads during a subset of the plurality of regular transmission intervals.

5. The system of claim 4, wherein the sniff delay sequence comprises a preset sequence.

6. The system of claim 4, wherein the sniff delay sequence comprises an exponential sniff delay sequence.

7. The system of claim 6, the operations further comprising:
transmitting, to the remote computing device and based on the exponential sniff delay sequence, a first data packet after a first time interval, a second data packet after a second time interval, and a third data packet after a third time interval, and
wherein the first time interval is initialized when the transmission of the data payload has been paused, wherein the first time interval has the same length as the regular transmission interval, wherein the second time interval is K-times the length of the regular transmission interval, and the third time interval is K-times the length of the second time interval.

8. The system of claim 4, wherein a length of the regular transmission interval is 20 ms.

9. The system of claim 1, wherein the remote computing device is configured to receive the null payloads based on the payload transmission cadence.

10. The system of claim 1, wherein the remote computing device is configured to receive the null payloads based on the modified transmission cadence, and wherein the remote computing device is configured to synchronize receipt of the null payloads from the base computing device based on the sniff delay sequence.

11. The system of claim 10, wherein the remote computing device is a media accessory device, and the operations further comprising:
detecting that the media accessory device is removed from use by a user;
subsequent to the detecting that the media accessory device is removed, waiting for a threshold amount of time, and
wherein the initiating of the transmission of the null payloads is based on the modified transmission cadence commences after passage of the threshold of time.

12. The system of claim 1, wherein the base computing device is configured to store a plurality of candidate sniff delay sequences, and wherein the sniff delay sequence is selected from the plurality of candidate sniff delay sequences.

13. The system of claim 12, wherein the sniff delay sequence is selected based on one or more of network bandwidth, or a power level of the base computing device.

14. The system of claim 12, wherein the remote computing device is configured to receive the null payloads based on the modified transmission cadence, the operations further comprising:
communicating the selected sniff delay sequence to the remote computing device prior to the initiating of the transmission of the null payloads based on the modified transmission cadence.

15. The system of claim 1, wherein the initiating of the transmission of the null payloads based on the modified transmission cadence commences after passage of a threshold of time.

16. The system of claim 1, wherein the Bluetooth communication link is associated with an Audio Stream Endpoints (ASE) state transitions machine, and wherein the initiating of the transmission of the null payloads based on the modified transmission cadence comprises bypassing the ASE state transitions machine.

17. A remote computing device comprising:
a controller configured to receive transmitted data from a base computing device over a Bluetooth communication link associated with a payload transmission cadence; and
one or more processors operable to perform operations, the operations comprising:
detecting a pause in a transmission of data payloads from the base computing device to the remote computing device over the Bluetooth communication link; and
subsequent to detecting the pause in the transmission of the data payloads, receiving, from the base computing device, null payloads at a modified transmission cadence based on a sniff delay sequence, wherein a number of null payloads received during a time interval is smaller for the modified transmission cadence than for the payload transmission cadence.

18. The remote computing device of claim 17, wherein the Bluetooth communication link comprises a low-energy connected isochronous stream (CIS) communication link.

19. The remote computing device of claim 17, wherein the Bluetooth communication link is configured to be terminated after a preset timeout interval, and wherein the modified transmission cadence extends the preset timeout interval.

20. A method comprising:
detecting, by a base computing device configured to transmit data over a Bluetooth communication link, a pause in a transmission of data payloads to a remote computing device over the Bluetooth communication link, wherein the Bluetooth communication link is associated with a payload transmission cadence, and wherein the remote computing device is configured to receive transmitted data from the base computing device over the Bluetooth communication link; and
subsequent to detecting the pause in the transmission of the data payloads, initiating transmission of null payloads at a modified transmission cadence based on a sniff delay sequence, wherein a number of null payloads transmitted during a time interval is smaller for the modified transmission cadence than for the payload transmission cadence.
